(19) United States
(12) Patent Application Publication
(10) Pub. No.: US 2023/0047727 A1
(43) Pub. Date: Feb. 16, 2023

(54) POSITIONING MEASUREMENT REPORTING METHOD AND CONFIGURATION METHOD, APPARATUS, AND ELECTRONIC DEVICE

(71) Applicant: VIVO MOBILE COMMUNICATION CO., LTD., Chang'an Dongguan (CN)

(72) Inventors: Ye SI, Chang'an Dongguan (CN); Yuanyuan WANG, Chang'an Dongguan (CN); Huaming WU, Chang'an Dongguan (CN)

(21) Appl. No.: 17/973,882

(22) Filed: Oct. 26, 2022

Related U.S. Application Data
(63) Continuation of application No. PCT/CN2021/089579, filed on Apr. 25, 2021.

(30) Foreign Application Priority Data
Apr. 30, 2020 (CN) 202010368260.X

(51) Int. Cl. H04W 64/00; H04W 72/10

(52) U.S. Cl. CPC H04W 64/003; H04W 72/10

(57) ABSTRACT

This application discloses a positioning measurement reporting method and configuration method, an apparatus, and an electronic device. The positioning measurement reporting method includes: obtaining priority information of positioning; and performing at least one of the following operations based on the priority information: measuring a positioning signal; and reporting positioning information.

### CROSS-REFERENCE TO RELATED APPLICATIONS

This application is a continuation of International Application No. PCT/CN2021/089579, filed on Apr. 25, 2021, which claims priority to Chinese Patent Application No. 202010368260.X filed in China on Apr. 30, 2020, which is incorporated herein by reference in its entirety.

### TECHNICAL FIELD

The present disclosure relates to the field of communications technologies, and in particular, to a positioning measurement reporting method and configuration method, an apparatus, and an electronic device.

### BACKGROUND

In the related art, positioning of user equipment (User Equipment, UE) requires a smaller delay and lower power consumption. In order to achieve this, the UE needs to reduce measurement on a positioning signal and reduce reporting of a corresponding measurement result without reducing the positioning accuracy, so as to reduce the delay of measurement and reporting, and reduce the power consumption of the UE. However, in the related art, it is not specified how the UE reduces the measurement and the reporting. If the UE reduces the measurement and the reporting blindly, the positioning accuracy is bound to be greatly reduced.

### SUMMARY

According to a first aspect of this application, a positioning measurement reporting method performed by a terminal is provided, which includes:

obtaining priority information of positioning; and

performing at least one of the following operations based on the priority information:

measuring a positioning signal; and

reporting positioning information.

According to a second aspect of this application, a positioning measurement configuration method performed by a network-side device is provided, which includes:

sending priority configuration information to a terminal, where the priority configuration information includes priority information of positioning, and the priority information is used to perform at least one of the following operations:

measuring a positioning signal; and

reporting positioning information.

According to a third aspect of this application, a positioning measurement reporting apparatus is provided, where the apparatus is applied to a terminal and includes:

an obtaining module, configured to obtain priority information of positioning; and

a processing module, configured to perform at least one of the following operations based on the priority information:

measuring a positioning signal; and

reporting positioning information.

According to a fourth aspect of this application, a positioning measurement configuration apparatus is provided, where the apparatus is applied to a network-side device and includes:

a sending module, configured to send priority configuration information to a terminal, where the priority configuration information includes priority information of positioning, and the priority information is used to perform at least one of the following operations:

measuring a positioning signal; and

reporting positioning information.

According to a fifth aspect of this application, an electronic device is provided, which includes a processor, a memory, and a program or an instruction stored in the memory and executable on the processor. When the program or the instruction is executed by the processor, steps of the foregoing method are implemented.

According to a sixth aspect of this application, a readable storage medium is provided, where the readable storage medium stores a program or an instruction, and the program or the instruction is executed by a processor to implement steps of the foregoing method.

According to a seventh aspect of this application, a chip is provided, where the chip includes a processor and a communication interface. The communication interface is coupled to the processor, and the processor is configured to run a program or an instruction to implement the method provided in the first aspect and the second aspect.

In the embodiments of this application, the terminal may measure the positioning signal and/or report the positioning information based on the obtained priority information. In this way, on the premise of ensuring the positioning accuracy, the positioning delay and the power consumption of the terminal can be reduced.

### BRIEF DESCRIPTION OF DRAWINGS

To describe the technical solutions in the embodiments of this application more clearly, the following briefly describes the accompanying drawings required in the embodiments of this application. Apparently, the accompanying drawings in the following descriptions show merely some embodiments of the present disclosure, and a person of ordinary skill in the art may still derive other drawings from these accompanying drawings without creative efforts.

FIG. 1 is a block diagram of a wireless communication system;

FIG. 2 is a schematic flowchart of a positioning measurement reporting method according to an embodiment of this application;

FIG. 3 is a schematic flowchart of a positioning measurement configuration method according to an embodiment of this application;

FIG. 4 is a schematic structural diagram of a module of UE according to an embodiment of this application;

FIG. 5 is a schematic structural diagram of a module of a network-side device according to an embodiment of this application;

FIG. 6 is a block diagram of a terminal according to an embodiment of this application; and

FIG. 7 is a block diagram of a network-side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not necessarily describe a specific order or sequence. It should be understood that the data used in such a way is interchangeable in proper circumstances, so that the embodiments of this application can be implemented in a sequence other than the sequence illustrated or described herein. In addition, in the specification and claims, “and/or” is used to indicate at least one of connected objects, and the character “/” usually indicates that associated objects are in an “or” relationship.

The technology described in this specification is not limited to the Long Term Evolution (Long Term Evolution, LTE)/LTE-Advanced (LTE-Advanced, LTE-A) system. It can also be applied in various wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), Single-carrier Frequency-Division Multiple Access (Single-carrier Frequency-Division Multiple Access, SC-FDMA) and other systems. The terms “system” and “network” are often interchangeably used. The CDMA system can implement radio technologies such as CDMA2000 and universal terrestrial radio access (Universal Terrestrial Radio Access, UTRA). UTRA includes wideband CDMA (Wideband Code Division Multiple Access, WCDMA) and other CDMA variants. The TDMA system may implement a radio technology such as Global System for Mobile Communication (Global System for Mobile Communication, GSM). The OFDMA system can implement radio technologies such as ultra mobile broadband (Ultra Mobile Broadband, UMB), evolved UTRA (Evolution-UTRA, E-UTRA), IEEE 802.11 (Wi-Fi), IEEE 802.16 (WiMAX), IEEE 802.20, and Flash-OFDM. UTRA and E-UTRA are a part of an universal mobile telecommunications system (Universal Mobile Telecommunications System, UMTS). LTE and more advanced LTE (such as LTE-A) are new UMTS versions that use E-UTRA. The UTRA, E-UTRA, UMTS, LTE, LTE-A, and GSM are described in documents from an organization named “3rd Generation Partnership Project” (3rd Generation Partnership Project, 3GPP). CDMA2000 and UMB are described in the documents of the organization named the “3rd Generation Partnership Project 2” (3GPP2). The technologies described in this specification may be used in the systems and radio technologies mentioned above, and may also be used in another system and radio technology. However, an NR system is described in the following description for illustrative purposes, and an NR terminology is used in most of the following description, although these technologies can also be applied to applications other than the NR system application.

The following description provides examples and does not limit the scope, applicability, or configuration set forth in the claims. Changes may be made to the function and arrangement of discussed elements without deviating from the spirit and scope of the present disclosure. In various examples, various procedures or components may be omitted, replaced, or added appropriately. For example, the described method may be performed according to a sequence different from the described sequence, and various steps may be added, omitted, or combined. In addition, features described with reference to some examples may be combined in other examples.

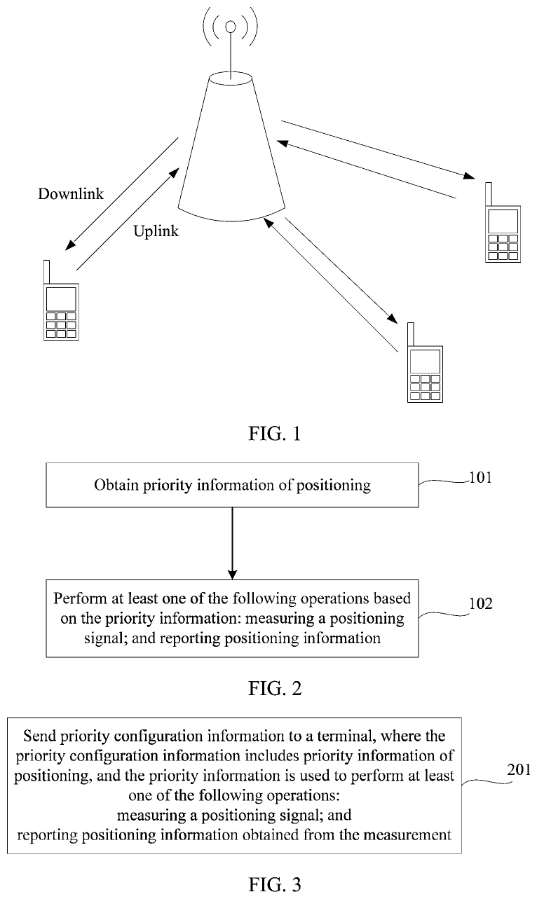

Referring to FIG. 1, FIG. 1 is a block diagram of a wireless communications system to which an embodiment of this application may be applied. The wireless communications system includes a terminal 11 and a network-side device 12. The terminal 11 may also be referred to as a terminal device or user equipment (User Equipment, UE). The terminal 11 may be a terminal-side device such as a mobile phone, a tablet personal computer (Tablet Personal Computer), a laptop computer (Laptop Computer), a personal digital assistant (Personal Digital Assistant, PDA), a mobile Internet device (Mobile Internet Device, MID), a wearable device (Wearable Device), or an in-vehicle device. It should be noted that a specific type of the terminal 11 is not limited in the embodiments of this application. The network-side device 12 may be a base station or a core network, where the base station may be a base station in 5G or a later version (for example, a gNB and a 5G NR NB), a base station in another communications system (for example, an eNB, a WLAN access point, or another access point), or a location server (for example, an E-SMLC or a location manager function (LMF)). The base station may be referred to as a NodeB, an evolved NodeB, an access point, a base transceiver station (Base Transceiver Station, BTS), a radio base station, a radio transceiver, a basic service set (Basic Service Set, BSS), an extended service set (Extended Service Set, ESS), a NodeB, an evolved NodeB (eNB), a home NodeB, a home evolved NodeB, a WLAN access point, a Wi-Fi node, or another appropriate term in the art. As long as same technical effects are achieved, the base station is not limited to a specified technical term. It should be noted that, in the embodiments of this application, the base station in the NR system is merely used as an example, but does not limit a specific type of the base station.

The base station may communicate with the terminal 11 under the control of a base station controller. In various examples, the base station controller may be a part of a core network or some base stations. Some base stations may communicate control information or user data with a core network through backhaul. In some examples, some of these base stations may communicate directly or indirectly with each other by using a backhaul link, and the backhaul link may be a wired or wireless communication link. The wireless communications system may support operations on multiple carriers (waveform signals of different frequencies). A multi-carrier transmitter can simultaneously transmit modulated signals on the multiple carriers. For example, each communication link may be a multi-carrier signal modulated according to various radio technologies. Each modulated signal may be sent on a different carrier and may carry control information (for example, a reference signal or a control channel), overhead information, data, and the like.

The base station may perform wireless communication with the terminal 11 by using one or more access point antennas. Each base station may provide communication coverage for a respective corresponding coverage area. The coverage area of the access point may be divided into sectors that constitute only a part of the coverage area. The wireless communications system may include different types of base stations (for example, macro base stations, micro base stations, or femto base stations). The base station may also use different radio technologies, such as cellular or WLAN radio access technologies. The base station may be associated with a same access network or operator deployment or different access network or operator deployments. Coverage areas of different base stations (including coverage areas of base stations of a same type or different types, coverage areas using a same radio technology or different radio technologies, or coverage areas belonging to a same access network or different access networks) may overlap.

An embodiment of this application provides a positioning measurement reporting method, applied to a terminal. As shown in FIG. 2, the method includes the following steps.

Step 101: Obtain priority information of positioning.

Step 102: Perform at least one of the following operations based on the priority information:

measuring a positioning signal; and

reporting positioning information.

In this embodiment, the terminal may measure the positioning signal and/or report the positioning information based on the obtained priority information, and measure a positioning signal with a higher priority and/or report positioning information with a higher priority preferentially. In this way, on the premise of ensuring the positioning accuracy, the positioning delay and the power consumption of the terminal can be reduced.

A type of the positioning information includes, but is not limited to, at least one of the following: position estimation, result measurement, and event information. The positioning information may be associated with the positioning signal. For example, the positioning information is a measurement result of the positioning signal, or the position estimation is calculated based on the measurement result of the positioning signal, and the positioning information reported by the UE is the measurement result or the position estimation based on the positioning signal. The positioning information may also not be associated with the positioning signal. For example, the positioning information may be the event information (for example, the UE moves beyond a specific threshold), and measurement on the positioning signal is not required at this time. The positioning information reported by the UE is the event information and is independent of signal measurement.

In an optional embodiment of this application, the obtaining priority information of positioning includes any one of the following:

receiving priority configuration information sent by a network-side device, where the priority configuration information includes the priority information;

obtaining the priority information defined by a protocol;

obtaining the priority information which is pre-configured; and

determining, by the terminal, the priority information.

The network-side device may be a serving base station (or referred to as a serving cell) or a location server, and the location server may be a location management function (Location Management Function, LMF) or an enhanced-serving mobile location center (Enhanced-Serving Mobile Location Center, E-SMLC). The priority configuration information includes at least one of the following:

a radio resource control (Radio Resource Control, RRC) message;

a media access control (Media Access Control, MAC) control element (Control Element, CE);

downlink control information (Downlink Control Information, DCI);

LTE positioning protocol (LTE positioning protocol, LPP) signaling; and

broadcast signaling.

Optionally, the priority configuration information may be configured by various signaling to finally determine one or more priority configurations. For example, a plurality of types of priority configuration information are configured by LPP signaling or RRC signaling, and one type of priority configuration information is indicated by DCI signaling.

Optionally, the priority configuration information may be combined with (or pre-configured) priority information of various signaling and protocols to finally determine one or more priority configurations. For example, the protocol agrees or pre-configures a plurality of priority configurations, and one of the priority configurations is indicated by the LPP or the DCI signaling.

In an embodiment of this application, the positioning signal is a reference signal for positioning measurement, and the positioning signal includes at least one of the following:

a positioning reference signal (Positioning Reference Signal, PRS);

a synchronization signal block (Synchronization Signal Block, SSB); and

a channel state information reference signal (Channel State Information Reference Signal, CSI-RS).

In an optional embodiment of this application, if the positioning information is positioning information associated with the positioning signal, and the terminal need to perform measuring the positioning signal and reporting positioning information, based on the priority information,

a priority order of measuring the positioning signal is consistent with a priority order of reporting the positioning information. The association refers to that the positioning information is positioning information obtained based on the measurement result of the positioning signal, for example, the positioning information is the measurement result of the positioning signal.

In an optional embodiment of this application, the priority information includes, but is not limited to, at least one of the following that is configured, agreed, or selected by the target object:

a positioning mode;

a type of reported positioning information;

a type of a positioning measurement quantity;

a transmission and reception point (transmission and reception point, TRP);

a positioning frequency layer;

a positioning signal resource set; and

a positioning signal resource.

In a specific embodiment, the priority information indicates sorting based on the positioning mode. The positioning mode may also be referred to as a positioning method or a positioning technology. If the UE supports a plurality of positioning modes, the UE preferentially measures signals corresponding to one or more positioning modes with high priority and/or reports positioning information of one or more positioning modes with high priority. The positioning mode includes but is not limited to at least one of the following: a downlink time difference of arrival (Downlink Time Difference of Arrival, DL-TDOA), a downlink angle of divergence (DL-AOD), a multi-round-trip time (Multi-Round-Trip Time, Multi-RTT), an evolved cell (IDE-CID), an assisting-global navigation satellite (Assisting-Global Navigation Satellite System, A-GNSS), and the like. In a specific example, the UE may report a DL-TDOA measurement result preferentially.

In a specific embodiment, the priority information indicates sorting based on a type of the reported positioning information. If the UE supports a plurality of positioning information reporting types, for a specific positioning mode and/or a specific positioning manner (such as a UE-assisted positioning manner, a UE-based positioning manner, and a standalone positioning manner), a priority order of positioning information types is determined. A type of the positioning information includes, but is not limited to, at least one of the following: position estimation, result measurement, and event information. The event information may be area event information: an event that the UE enters, leaves, or stays within a predefined geographical area, and the event information may also be motion event information: an event that the UE moves more than a predefined linear distance from a previous position, and the event information may also be UE availability: any event that the core network establishes contact with the UE. In a specific example, the UE may report the position estimation first, the measurement result second, and then the event information. In another example, the UE reports the event information first, the measurement result second, then the position estimation, and the like. Furthermore, the UE may report the measurement result first, and then report the position estimation; or the UE may report the position estimation first, and then report the measurement result. Alternatively, the UE reports at least positioning information with a high priority, and then selectively reports positioning information with a low priority, and the selective reporting may further depend on the indication of the network side, the agreement in the protocol, or the selection of the UE. Alternatively, the UE reports positioning information with a high priority, such as position estimation, and when the positioning information with a high priority, such as the position estimation, is unavailable, the UE reports positioning information with a low priority for replacement, such as reporting the measurement result for replacement. Alternatively, when priorities of a plurality of types of positioning information are the same, the UE simultaneously reports a plurality of types of positioning information.

In a specific embodiment, the priority information indicates sorting based on a type of a positioning measurement quantity. For a specific positioning mode and/or a specific positioning manner, if the UE is configured to measure and/or report a plurality of measurement quantities, a type sorting of the positioning measurement quantities is determined. For example, for the DL-TDOA positioning mode and the UE-assist positioning manner, measuring or reporting a reference signal time difference (Reference Signal Time Difference, RSTD) has a high priority, and measuring and reporting a reference signal receiving power (Reference Signal Receiving Power, RSRP) has a low priority.

In a specific embodiment, the priority information indicates sorting based on the TRP, and for a specific positioning mode (such as the DL-TDOA or the DL-AOD) and/or a specific positioning manner, the UE preferentially measures a positioning signal under a TRP with a high priority and/or preferentially reports a measurement result of the TRP with a high priority. For example, the UE preferentially measures and/or reports, based on the priority order of TRPs indicated by the network side, a measurement result of the TRP with a high priority. Alternatively, the UE preferentially measures and/or reports, based on the indication of the network side, the agreement in the protocol, or the selection of the UE, a measurement result of the TRP with a good measurement quality (such as a high RSRP/signal to interference plus noise ratio (Signal to Interference plus Noise Ratio, SINR) and a good line of sight (Line of Sight, LOS) condition).

In a specific embodiment, the priority information indicates sorting based on a positioning frequency layer. For a specific positioning mode and/or a specific positioning manner, the UE preferentially measures and/or reports a measurement result of the positioning frequency layer with a high priority. For example, the UE preferentially measures and/or reports, based on the priority order of positioning frequency layers indicated by the network side, a measurement result of a positioning frequency layer with a high priority. Alternatively, the UE preferentially measures and/or reports a measurement result of the positioning frequency layer that is close to a frequency point of a bandwidth part (Bandwidth Part, BWP) of the UE active DL.

In a specific embodiment, if the priority information is configured for the positioning signal resource set and/or the positioning signal resource, the priority information includes at least one of the following priority rules:

prioritizing based on the type of the positioning signal. In a specific example, the UE may preferentially measure and/or report the measurement result of the aperiodic positioning signal. In another specific example: the aperiodic positioning signal has the highest priority, the semi-persistent positioning signal is the next, and the periodic positioning signal has the lowest priority;

prioritizing based on whether the positioning signals are within the measurement time window. In a specific example, positioning signals within the measurement time window are regarded as the high priority, and positioning signals outside the measurement time window are regarded as the low priority. The UE preferentially measures the positioning signal within the time window and/or reports the measurement result of the positioning signal within the measurement time window; and the time window may be a positioning time measurement window, such as a positioning MTC or a PRS MTC;

prioritizing based on whether the positioning signal is within the measurement gap time window. In a specific example, if the UE is configured with a measurement gap, and the duration of the existence of the PRS exceeds a length of the gap, positioning signals within the gap time window are regarded as the high priority, and positioning signals outside the gap time window are regarded as the low priority. The UE preferentially measures the positioning signal within the gap time window and/or preferentially reports the measurement result of the positioning signal within the gap time window;

prioritizing based on whether the positioning signal has an associated spatial reference signal (QCL-D source RS). For example, the measurement result of the positioning signal with the spatial reference signal is preferentially reported. Further, if the positioning signal has an associated spatial reference signal, the priority information may include at least one of the following: preferentially measuring and/or reporting the measurement result of the positioning signal that does not require the UE to measure the spatial reference signal; and preferentially measuring and/or reporting the measurement result of the positioning signal with a good spatial reference signal quality;

prioritizing based on whether the positioning signal has an associated quasi-co-location reference signal, for example, preferentially measuring and/or reporting the measurement result of the positioning signal with the QCL-C reference signal;

prioritizing based on a measurement quality of the positioning signal, for example, preferentially measuring and/or reporting the measurement result of the positioning signal with a high measurement quality; and

prioritizing based on priorities/a priority of the positioning signal resource and/or the positioning signal resource set indicated by the network-side device.

In an optional embodiment of this application, the reporting positioning information based on the priority information includes: reporting positioning information corresponding to a target object for which the priority information is configured, based on at least one reporting mode, where the reporting mode includes: aperiodic reporting, periodic reporting, semi-persistent reporting, event-triggered reporting, immediate reporting, early fix reporting, and non-connected state reporting.

For the reporting mode of immediate reporting, the network side indicates a response time, and the UE needs to report position information before the response time. The early fix reporting refers to that after configuring the immediate reporting, the network side further configures a time smaller than the response time. The UE may report an early measurement result or early position estimation information at an earlier time. The non-connected state includes an idle state/or an inactive state.

In some embodiments, the terminal is configured with a plurality of reporting modes, the priority information includes a priority of the reporting mode, and the priority of the reporting mode includes at least one of the following:

a priority of the aperiodic reporting is higher than a priority of the periodic reporting;

a priority of the aperiodic reporting is higher than a priority of the semi-persistent reporting;

a priority of the aperiodic reporting is higher than a priority of the immediate reporting;

a priority of the aperiodic reporting is higher than a priority of the early fix reporting;

a priority of the semi-persistent reporting is higher than a priority of the periodic reporting; and

a priority of the early fix reporting is higher than a priority of the immediate reporting.

In some embodiments, the terminal is configured with a plurality of reporting modes, the priority information includes a priority of reporting the positioning information and a priority of the reporting mode, and the reporting positioning information corresponding to a target object for which the priority information is configured, based on at least one reporting mode includes: reporting the positioning information corresponding to the target object for which the priority information is configured, based on a first reporting mode, where a priority of the first reporting mode matches a priority of the positioning information. For example, the priority of the first reporting mode for reporting the positioning information is the same as the priority of the positioning information.

Optionally, if the UE is configured with a plurality of reporting modes, the UE reports the positioning information with higher priority in the reporting mode with higher priority.

Optionally, the mapping relationship between the positioning information to be reported and the reporting mode may be indicated by the network side or agreed in a protocol. The mapping relationship is related to the priority of the positioning information and the priority of the reporting mode. For example, the positioning information with a priority level of 1 and 2 is reported in the reporting mode with the priority level of 1; and the positioning information with a priority level of 3 is reported in the reporting mode with the priority level of 2. Certainly, in addition to being indicated by the network side or agreed in a protocol, the UE may also independently select a mapping relationship between the positioning information and the reporting mode.

In some embodiments, as for a same reporting mode, the terminal reports the positioning information based on the priority information of the positioning information.

In some embodiments, the priority information includes a priority of the positioning signal, and the measuring a positioning signal based on the priority information includes:

if a first positioning signal is unavailable, measuring a second positioning signal, where a priority of the second positioning signal is lower than a priority of the first positioning signal.

Further, the method further includes:

reporting a reason correspond to the first positioning signal is unavailable to the network-side device. For example, signal measurement failure, unavailable uplink resources, and the like.

In some embodiments, the priority information includes a priority of reporting the positioning information, and the reporting positioning information based on the priority information includes:

if first positioning information is unavailable, measuring second positioning information, where a priority of the second positioning information is lower than a priority of the first positioning information.

Further, the method further includes:

reporting a reason correspond to the first positioning information is unavailable to the network-side device. For example, signal measurement failure, unavailable uplink resources, and the like.

The priority information may also be used in the case of insufficient uplink resources. The reporting positioning information based on the priority information includes:

if a resource required for all the positioning information exceeds an uplink resource, reporting, based on the priority information, part of the positioning information that can be carried in the uplink resource. That is, the UE can preferentially carry, based on the priority information, the positioning information with higher priority in the uplink resource.

Further, after the part of the positioning information that can be carried in the uplink resource is reported based on the priority information, or after the positioning information whose priority is higher than the preset priority or not lower than the preset priority is reported, if there is still unreported positioning information or positioning information whose priority is not high enough (such as in the low priority), the method further includes:

performing any of the following operations on unreported positioning information:

delaying reporting the unreported positioning information;

reporting the unreported positioning information based on an indication of the network-side device; and

canceling reporting the unreported positioning information.

An example of delayed reporting is: after the UE reports the part of the positioning information aperiodically, if there is still unreported positioning information or positioning information whose priority is not high enough, the UE may report the unreported positioning information no later than a response time, or report the unreported positioning information in a subsequent periodic report, a semi-persistent report, an aperiodic report, or an event-triggered report.

In some embodiments, the priority information includes a measurement priority of the positioning signal, and the measuring a positioning signal based on the priority information includes at least one of the following:

performing a first operation, where the first operation is: measuring a positioning signal with a measurement priority higher than a first preset priority; and

performing a second operation, where the second operation is: not measuring a positioning signal with a measurement priority not higher than a second preset priority.

The first preset priority and the second preset priority are indicated by the network-side device, defined by the protocol, or determined by the terminal, which are higher than a case including greater than and equal to.

The first operation and the second operation are indicated by the network-side device, defined by the protocol, or determined by the terminal. Certainly, the UE may measure the positioning signal with a priority not higher than the second preset priority, which depends on the indication of the network side, the agreement in the protocol, or is determined by the terminal.

In some embodiments, the priority information includes a priority of reporting the positioning information, and the reporting positioning information based on the priority information includes at least one of the following:

performing a third operation, where the third operation is: reporting positioning information with a priority higher than a third preset priority; and

performing a fourth operation, and not reporting positioning information with a priority not higher than a fourth preset priority.

The third preset priority and the fourth preset priority are indicated by the network-side device, defined by the protocol, or determined by the terminal, which are higher than a case including greater than and equal to.

The third operation and the fourth operation are indicated by the network-side device, defined by the protocol, or determined by the terminal. Certainly, the UE may report the positioning information with a priority not higher than the fourth preset priority, which depends on the indication of the network side, the agreement in the protocol, or is determined by the terminal.

In a specific embodiment, when the UE measures the positioning signal and/or reports the positioning information, for the priority order of a specific object, at least one of the following modes is indicated by the network side, defined by the protocol, or selected by the UE:

(1) Classify by priority, and list objects or object IDs of a same priority as a group.

Optionally, objects in a same group may be further prioritized based on the order of objects or object IDs.

(2) The order of objects in the object list is corresponding to the priority order.

(3) Indicate priority classification information in an information element (Information Element, IE) associated with a specific object.

(4) Sort the priority order based on the object ID, such as assigning a small ID to an object with a high priority.

A priority of a specific object may include, but is not limited to at least one of priorities of a plurality of TRPs, priorities of a plurality of positioning frequency layers, priorities of a plurality of positioning signal resource sets, priorities of a plurality of positioning signal resources, priorities of a plurality of types of positioning information, priority of a plurality of positioning modes, or priorities of a plurality of reporting modes.

Alternatively, the TRP priority is taken as an example, but it is also applicable to a specific object. Optionally, the plurality of TRPs herein may be TRPs in a specific positioning frequency layer or TRPs in a plurality of positioning frequency layers.

As for (1), the priority information may be indicated in the following manner, such as in the form of a table. 1 represents the highest priority, and 4 represents the lowest priority.

| Priority level | TRP ID |
|---|---|
| 1 | 1, 5, 9 |
| 2 | 2, 4 |
| 3 | 8 |
| 4 | |

Optionally, for TRPs of the same priority, the priority order may be further determined based on an order of the TRP ID. For example, there are 3 TRPs with a priority of 1, and the TRP with the TRP ID of 1 has the highest priority.

Optionally, the network side may further instruct the UE to measure at least the positioning signal of the TRP above a specific priority and/or report the measurement result of the TRP above a specific priority.

As for (2), when configuring information of a plurality of TRPs, the network side configures a TRP list, and an order of the TRP in the list indicates the priority of the TRP. For example, a first TRP in the list has the highest priority, followed by the next.

As for (3), when configuring information of a plurality of TRPs, the network side indicates priority level information in corresponding TRP configuration information. For example, in the TRP configuration information whose TRP ID is 1, the priority is indicated as ‘high’.

As for (4), when configuring a plurality of pieces of TRP information, the network side implicitly indicates the priority by using the TRP ID. For example, the smallest TRP ID has the highest priority.

In some embodiments, before the obtaining priority information of positioning, the method further includes:

reporting priority information of positioning that is expected by the terminal to the network-side device. That is, the UE reports preference priority information as priority information of positioning that is expected by the terminal to the network-side device. The reported priority information of positioning that is expected by the terminal may include at least one of the measurement priority of the positioning signal and the reporting priority of the positioning information. The reported priority information of positioning that is expected by the terminal may be used to assist the network-side device to further determine the priority information to be sent to the UE, or to assist the network-side device to send appropriate assistance information to the UE.

Optionally, signaling for reporting the priority information of positioning that is expected by the terminal may be at least one of LPP signaling and RRC signaling.

An embodiment of this application provides a positioning measurement configuration method, applied to a network-side device. As shown in FIG. 3, the method includes the following steps.

Step 201: Send priority configuration information to a terminal, where the priority configuration information includes priority information of positioning, and the priority information is used to perform at least one of the following operations:

measuring a positioning signal; and

reporting positioning information.

In this embodiment, the network-side device may send priority information to the terminal, so that the terminal may measure the positioning signal and/or report the positioning information based on the obtained priority information, and measure a positioning signal with a higher priority and/or report positioning information with a higher priority preferentially. In this way, on the premise of ensuring the positioning accuracy, the positioning delay and the power consumption of the terminal can be reduced.

A type of the positioning information includes, but is not limited to, at least one of the following: position estimation, result measurement, and event information. The positioning information may be associated with the positioning signal. For example, the positioning information is a measurement result of the positioning signal, or the position estimation is calculated based on the measurement result of the positioning signal, and the positioning information reported by the UE is the measurement result or the position estimation based on the positioning signal. The positioning information may also not be associated with the positioning signal. For example, the positioning information may be the event information (for example, the UE moves beyond a specific threshold), and measurement on the positioning signal is not required at this time. The positioning information reported by the UE is the event information and is independent of signal measurement.

The network-side device may be a serving base station (or referred to as a serving cell) or a location server, and the location server may be a location management function (Location Management Function, LMF) or an enhanced-serving mobile location center (Enhanced-Serving Mobile Location Center, E-SMLC). The priority configuration information includes at least one of the following:

a radio resource control (RRC) message;

a medium access control (MAC) control element (CE);

downlink control information (DCI);

LTE positioning protocol (LPP) signaling; and

broadcast signaling.

Optionally, the priority configuration information may be configured by various signaling to finally determine one or more priority configurations. For example, a plurality of types of priority configuration information are configured by LPP signaling or RRC signaling, and one type of priority configuration information is indicated by DCI signaling.

Optionally, the priority configuration information may be combined with (or pre-configured) priority information of various signaling and protocols to finally determine one or more priority configurations. For example, the protocol agrees or pre-configures a plurality of priority configurations, and one of the priority configurations is indicated by the LPP or the DCI signaling.

In an embodiment of this application, the positioning signal is a reference signal for positioning measurement, and the positioning signal includes at least one of the following:

a positioning reference signal (PRS);

a synchronization signal block (SSB); and

a channel state information (CSI)-reference signal (RS).

In an optional embodiment of this application, the priority information includes, but is not limited to, at least one of the following that is configured, agreed, or selected by the target object:

a positioning mode;

a type of reported positioning information;

a type of a positioning measurement quantity;

a transmission and reception point (TRP);

a positioning frequency layer;

a positioning signal resource set; and

a positioning signal resource.

In a specific embodiment, the priority information indicates sorting based on the positioning mode. If the UE supports a plurality of positioning modes, the UE preferentially measures signals corresponding to one or more positioning modes with high priority and/or reports positioning information of one or more positioning modes with high priority. The positioning mode includes but is not limited to at least one of the following: a downlink time difference of arrival (Downlink Time Difference of Arrival, DL-TDOA), a downlink angle of divergence (DL-AOD), a Multi-RTT, an E-CIDA-GNSS, and the like. In a specific example, the UE may report a DL-TDOA measurement result preferentially.

In a specific embodiment, the priority information indicates sorting based on a type of the reported positioning information. If the UE supports a plurality of positioning information reporting types, for a specific positioning mode and/or a specific positioning manner (WUE-assisted, UE-based, and Standalone), a priority order of positioning information types is determined. A type of the positioning information includes, but is not limited to, at least one of the following: position estimation, result measurement, and event information. The event information may be area event information: an event that the UE enters, leaves, or stays within a predefined geographical area, and the event information may also be motion event information: an event that the UE moves more than a predefined linear distance from a previous position, and the event information may also be UE availability: any event that the core network establishes contact with the UE. In a specific example, the UE may report the position estimation first, the measurement result second, and then the event information. In another example, the UE reports the event information first, the measurement result second, then the position estimation, and the like. Furthermore, the UE may report the measurement result first, and then report the position estimation; or the UE may report the position estimation first, and then report the measurement result. Alternatively, the UE reports at least positioning information with a high priority, and then selectively reports positioning information with a low priority, and the selective reporting may further depend on the indication of the network side, the agreement in the protocol, or the selection of the UE. Alternatively, the UE reports positioning information with a high priority, such as position estimation, and when the positioning information with a high priority, such as the position estimation, is unavailable, the UE reports positioning information with a low priority for replacement, such as reporting the measurement result for replacement. Alternatively, when priorities of a plurality of types of positioning information are the same, the UE simultaneously reports a plurality of types of positioning information.

In a specific embodiment, the priority information indicates sorting based on a type of a positioning measurement quantity. For a specific positioning mode and/or a specific positioning manner, if the UE is configured to measure and/or report a plurality of measurement quantities, a type sorting of the positioning measurement quantities is determined. For example, for the DL-TDOA positioning mode and the UE-assist positioning manner, measuring or reporting a reference signal time difference (Reference Signal Time Difference, RSTD) has a high priority, and measuring and reporting a reference signal receiving power (Reference Signal Receiving Power, RSRP) has a low priority.

In a specific embodiment, the priority information indicates sorting based on the TRP, and for a specific positioning mode (such as the DL-TDOA or the DL-AOD) and/or a specific positioning manner, the UE preferentially measures a positioning signal under a TRP with a high priority and/or preferentially reports a measurement result of the TRP with a high priority. For example, the UE preferentially measures and/or reports, based on the priority order of TRPs indicated by the network side, a measurement result of the TRP with a high priority. Alternatively, the UE preferentially measures and/or reports, based on the indication of the network side, the agreement in the protocol, or the selection of the UE, a measurement result of the TRP with a good measurement quality (such as a high RSRP/signal to interference plus noise ratio (Signal to Interference plus Noise Ratio, SINR) and a good line of sight (Line of Sight, LOS) condition).

In a specific embodiment, the priority information indicates sorting based on a positioning frequency layer. For a specific positioning mode and/or a specific positioning manner, the UE preferentially measures and/or reports a measurement result of the positioning frequency layer with a high priority. For example, the UE preferentially measures and/or reports, based on the priority order of positioning frequency layers indicated by the network side, a measurement result of a positioning frequency layer with a high priority. Alternatively, the UE preferentially measures and/or reports a measurement result of the positioning frequency layer that is close to a frequency point of a bandwidth part (Bandwidth Part, BWP) of the UE active DL.

In a specific embodiment, if the priority information is configured for the positioning signal resource set and/or the positioning signal resource, the priority information includes at least one of the following priority rules:

prioritizing based on the type of the positioning signal. In a specific example, the UE may preferentially measure and/or report the measurement result of the aperiodic positioning signal. In another specific example: the aperiodic positioning signal has the highest priority, the semi-persistent positioning signal is the next, and the periodic positioning signal has the lowest priority;

prioritizing based on whether the positioning signals are within the measurement time window. In a specific example, positioning signals within the measurement time window are regarded as the high priority, and positioning signals outside the measurement time window are regarded as the low priority. The UE preferentially measures the positioning signal within the time window and/or reports the measurement result of the positioning signal within the measurement time window; and the time window may be a positioning time measurement window, such as a positioning MTC or a PRS MTC;

prioritizing based on whether the positioning signal is within the measurement gap time window. In a specific example, if the UE is configured with a measurement gap, and the duration of the existence of the PRS exceeds a length of the gap, positioning signals within the gap time window are regarded as the high priority, and positioning signals outside the gap time window are regarded as the low priority. The UE preferentially measures the positioning signal within the gap time window and/or preferentially reports the measurement result of the positioning signal within the gap time window;

prioritizing based on whether the positioning signal has an associated spatial reference signal (QCL-D source RS). For example, the measurement result of the positioning signal with the spatial reference signal is preferentially reported. Further, if the positioning signal has an associated spatial reference signal, the priority information may include at least one of the following: preferentially measuring and/or reporting the measurement result of the positioning signal that does not require the UE to measure the spatial reference signal; and preferentially measuring and/or reporting the measurement result of the positioning signal with a good spatial reference signal quality;

prioritizing based on whether the positioning signal has an associated quasi-co-location reference signal, for example, preferentially measuring and/or reporting the measurement result of the positioning signal with the QCL-C reference signal;

prioritizing based on a measurement quality of the positioning signal, for example, preferentially measuring and/or reporting the measurement result of the positioning signal with a high measurement quality; and

prioritizing based on priorities/a priority of the positioning signal resource and/or the positioning signal resource set indicated by the network-side device.

In an optional embodiment of this application, if the priority information is used to report the positioning information, the target object corresponding to the priority information includes at least one of the following reporting modes: aperiodic reporting, periodic reporting, semi-persistent reporting, event-triggered reporting, immediate reporting, early fix reporting, and non-connected state reporting.

For the reporting mode of immediate reporting, the network side indicates a response time, and the UE needs to report position information before the response time. The early fix reporting refers to that after configuring the immediate reporting, the network side further configures a time smaller than the response time. The UE may report an early measurement result or early position estimation information at an earlier time. The non-connected state includes an idle state/or an inactive state.

In some embodiments, the terminal is configured with a plurality of reporting modes, the priority information includes a priority of the reporting mode, and the priority of the reporting mode includes at least one of the following:

a priority of the aperiodic reporting is higher than a priority of the periodic reporting;

a priority of the aperiodic reporting is higher than a priority of the semi-persistent reporting;

a priority of the aperiodic reporting is higher than a priority of the immediate reporting;

a priority of the aperiodic reporting is higher than a priority of the early fix reporting;

a priority of the semi-persistent reporting is higher than a priority of the periodic reporting; and

a priority of the early fix reporting is higher than a priority of the immediate reporting.

In some embodiments, the terminal is configured with a plurality of reporting modes, the priority information includes a priority of reporting the positioning information and a priority of the reporting mode, and the priority of the reporting mode for reporting the positioning information matches the priority of the positioning information. For example, the priority of the first reporting mode for reporting the positioning information is the same as the priority of the positioning information.

Optionally, if the UE is configured with a plurality of reporting modes, the UE reports the positioning information with higher priority in the reporting mode with higher priority.

Optionally, the mapping relationship between the positioning information to be reported and the reporting mode may be indicated by the network side or agreed in a protocol. The mapping relationship is related to the priority of the positioning information and the priority of the reporting mode. For example, the positioning information with a priority level of 1 and 2 is reported in the reporting mode with the priority level of 1; and the positioning information with a priority level of 3 is reported in the reporting mode with the priority level of 2. Certainly, in addition to being indicated by the network side or agreed in a protocol, the UE may also independently select a mapping relationship between the positioning information and the reporting mode.

In some embodiments, before the sending priority configuration information to a terminal, the method further includes:

receiving priority information of positioning that is reported and expected by the terminal. That is, the UE reports preference priority information as priority information of positioning that is expected by the terminal to the network-side device. The reported priority information of positioning that is expected by the terminal may include at least one of the measurement priority of the positioning signal and the reporting priority of the positioning information. The reported priority information of positioning that is expected by the terminal may be used to assist the network-side device to further determine the priority information to be sent to the UE, or to assist the network-side device to send appropriate assistance information to the UE.

Optionally, signaling for reporting the priority information of positioning that is expected by the terminal may be at least one of LPP signaling and RRC signaling.

It should be noted that, in the positioning measurement reporting method provided in the embodiments of this application, the execution subject may be a positioning measurement reporting apparatus, or a module in the positioning measurement reporting apparatus for loading the positioning measurement reporting method. In the embodiments of this application, that the positioning measurement reporting apparatus loads the positioning measurement reporting method is used as an example to describe the positioning measurement reporting method provided in the embodiments of this application.

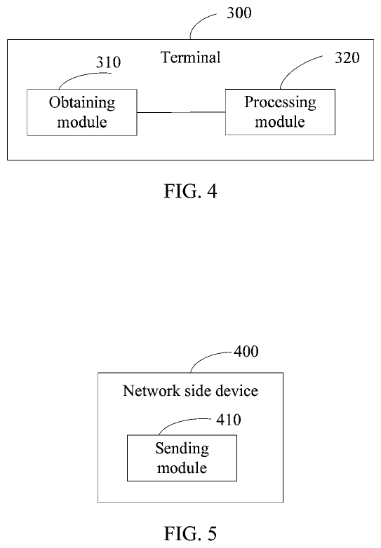

The positioning measurement reporting apparatus in the embodiments of this application is applied to UE 300. As shown in FIG. 4, the positioning measurement reporting apparatus includes:

an obtaining module 310, configured to obtain priority information of positioning; and

a processing module 320, configured to perform at least one of the following operations based on the priority information:

measuring a positioning signal; and

reporting positioning information.

In some embodiments, the priority information is configured for at least one of the following target objects:

a positioning mode;

a type of reported positioning information;

a type of a positioning measurement quantity;

a transmission and reception point (TRP);

a positioning frequency layer;

a positioning signal resource set; and

a positioning signal resource.

In some embodiments, the reporting positioning information based on the priority information includes: reporting positioning information corresponding to a target object for which the priority information is configured, based on at least one reporting mode, where the reporting mode includes: aperiodic reporting, periodic reporting, semi-persistent reporting, event-triggered reporting, immediate reporting, early fix reporting, and non-connected state reporting.

In some embodiments, the apparatus further includes:

a reporting module, configured to report priority information of positioning that is expected by the terminal to a network-side device.

The positioning measurement reporting apparatus in this embodiment of this application may be an apparatus, or may be a component, an integrated circuit, or a chip in the terminal. The apparatus may be a mobile electronic device or a non-mobile electronic device. For example, the mobile electronic device may be a mobile phone, a tablet computer, a laptop computer, a palmtop computer, an in-vehicle electronic device, a wearable device, an ultra-mobile personal computer (ultra-mobile personal computer, UMPC), a netbook, a personal digital assistant (personal digital assistant, PDA), or the like. The non-mobile electronic device may be a network attached storage (Network Attached Storage, NAS), a personal computer (personal computer, PC), a television (television, TV), an automated teller machine, a self-service machine, or the like. This is not specifically limited in the embodiments of this application.

The positioning measurement reporting apparatus in the embodiments of this application may be an apparatus with an operating system. The operating system may be an Android operating system, an iOS operating system, or another possible operating system. This is not specifically limited in the embodiments of this application.

The positioning measurement reporting apparatus provided in this embodiment of this application can implement the processes of the positioning measurement reporting method in the foregoing method embodiment. To avoid repetition, details are not described herein again.

It should be noted that, in the positioning measurement configuration method provided in the embodiments of this application, the execution subject may be a positioning measurement configuration apparatus, or a module in the positioning measurement configuration apparatus for loading the positioning measurement configuration method. In the embodiments of this application, that the positioning measurement configuration apparatus loads the positioning measurement configuration method is used as an example to describe the positioning measurement configuration method provided in the embodiments of this application.

The positioning measurement configuration apparatus provided in the embodiments of this application is applied to a network-side device 400. As shown in FIG. 5, the apparatus includes:

a sending module 410, configured to send priority configuration information to a terminal, where the priority configuration information includes priority information of positioning, and the priority information is used to perform at least one of the following operations:

measuring a positioning signal; and

reporting positioning information.

In some embodiments, the priority information is configured for at least one of the following target objects:

a positioning mode;

a type of reported positioning information;

a type of a positioning measurement quantity;

a transmission and reception point (TRP);

a positioning frequency layer;

a positioning signal resource set; and

a positioning signal resource.

In some embodiments, if the priority information is used to report the positioning information, the target object corresponding to the priority information includes at least one of the following reporting modes: aperiodic reporting, periodic reporting, semi-persistent reporting, event-triggered reporting, immediate reporting, early fix reporting, and non-connected state reporting.

In some embodiments, the apparatus further includes:

a receiving module, configured to receive priority information of positioning that is reported and expected by the terminal.

The positioning measurement configuration apparatus in the embodiments of this application may be an apparatus or a non-mobile electronic device. For example, the non-mobile electronic device may be a base station, a network attached storage (Network Attached Storage, NAS), a personal computer (personal computer, PC), a television (television, TV), an automated teller machine, a self-service machine, or the like. This is not specifically limited in the embodiments of this application.

The positioning measurement configuration apparatus in the embodiments of this application may be an apparatus with an operating system. The operating system may be an Android operating system, an iOS operating system, or another possible operating system. This is not specifically limited in the embodiments of this application.

The positioning measurement configuration apparatus provided in this embodiment of this application can implement the processes of the positioning measurement configuration method in the foregoing method embodiment. To avoid repetition, details are not described herein again.

Optionally, an embodiment of this application further provides an electronic device, including a processor, a memory, and a program or an instruction stored in the memory and executable on the processor. When the program or the instruction is executed by the processor, the processes of the embodiments of the positioning measurement reporting method and the positioning measurement configuration method are implemented, and a same technical effect can be achieved. To avoid repetition, details are not described herein again.

It should be noted that the electronic device in the embodiments of this application includes the mobile electronic device and the non-mobile electronic device.

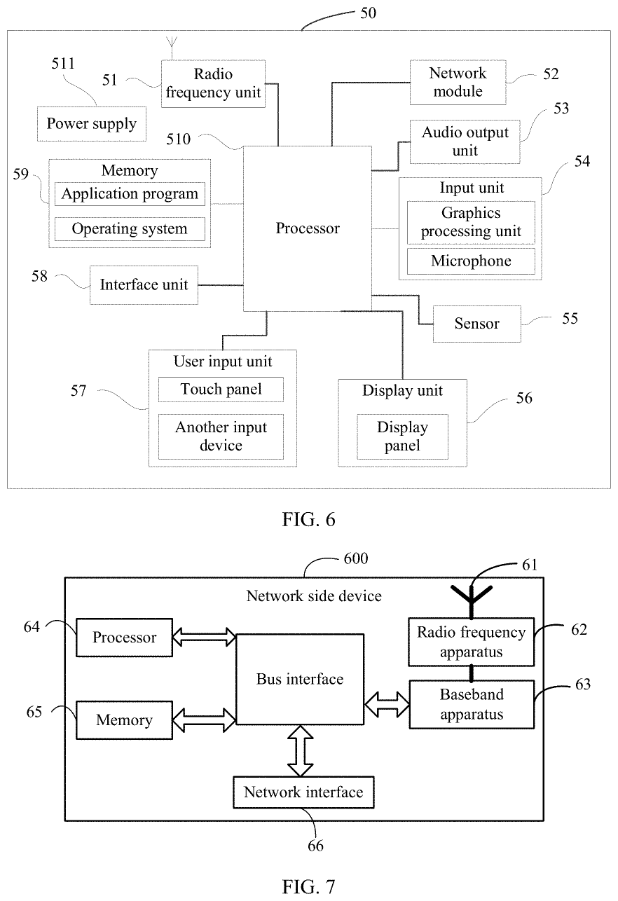

The electronic device in this embodiment may be a terminal. FIG. 6 is a schematic diagram of a hardware structure of a terminal according to the embodiments of the present disclosure. A terminal 50 includes but is not limited to components such as a radio frequency unit 51, a network module 52, an audio output unit 53, an input unit 54, a sensor 55, a display unit 56, a user input unit 57, an interface unit 58, a memory 59, a processor 510, and a power supply 511. It can be understood by a person skilled in the art that, the terminal structure shown in FIG. 6 does not constitute any limitation on the terminal, and the terminal may include more or fewer components than those shown in the figure, or combine some components, or have different component arrangements. In this embodiment of this application, the terminal includes, but is not limited to, a mobile phone, a tablet computer, a notebook computer, a palmtop computer, a vehicle-mounted terminal, a wearable device, a pedometer, or the like.

It should be understood that, in this embodiment of this application, the radio frequency unit 51 may be configured to receive and send information or a signal in a call process. Alternatively, after receiving downlink data from a base station, the radio frequency unit 501 sends the downlink data to the processor 510 for processing. In addition, the radio frequency unit 501 sends uplink data to the base station. Usually, the radio frequency unit 51 includes but is not limited to an antenna, at least one amplifier, a transceiver, a coupler, a low noise amplifier, a duplexer, and the like. In addition, the radio frequency unit 51 may also communicate with a network and other devices through a wireless communication system.

The memory 59 may be configured to store a software program and various data. The memory 59 may mainly include a program storage area and a data storage area. The program storage area may store an operating system, an application program required by at least one function (for example, a sound play function or an image display function), and the like. The data storage area may store data (for example, audio data or an address book) or the like created based on use of a mobile phone. In addition, the memory 59 may include a high-speed random access memory or a nonvolatile memory, for example, at least one disk storage device, a flash memory, or other volatile solid-state storage devices.

The processor 510 is a control center of the terminal, and connects all parts of the entire terminal by using various interfaces and lines. By running or executing a software program and/or a module stored in the memory 59 and invoking data stored in the memory 59, the processor 510 performs various functions of the terminal and data processing to perform overall monitoring on the terminal. The processor 510 may include one or more processing units. Preferentially, the processor 510 may be integrated with an application processor and a modem processor. The application processor mainly processes an operating system, a user interface, an application program, and the like, and the modem processor mainly processes wireless communication. It can be understood that, alternatively, the modem processor may not be integrated into the processor 510.

The terminal 50 may further include the power supply 511 (such as a battery) that supplies power to each component. Preferably, the power supply 511 may be logically connected to the processor 510 by using a power management system, so as to implement functions such as charging, discharging, and power consumption management by using the power management system.

In addition, the terminal 50 includes some function modules not shown, and details are not described herein.

The electronic device in this embodiment may be a network-side device. As shown in FIG. 7, the network-side device 600 includes an antenna 61, a radio frequency apparatus 62, and a baseband apparatus 63. The antenna 61 is connected to the radio frequency apparatus 62. In an uplink direction, the radio frequency apparatus 62 receives information by using the antenna 61, and sends the received information to the baseband apparatus 63 for processing. In a downlink direction, the baseband apparatus 63 processes to-be-sent information, and sends the to-be-sent information to the radio frequency apparatus 62. After processing the received information, the radio frequency apparatus 62 sends the information by using the antenna 61.

The foregoing band processing apparatus may be located in the baseband apparatus 63. In the foregoing embodiment, a method performed by the network-side device may be implemented in the baseband apparatus 63. The baseband apparatus 63 includes a processor 64 and a memory 65.

For example, the baseband apparatus 63 may include at least one baseband board. Multiple chips are disposed on the baseband board. As shown in FIG. 7, one chip is, for example, the processor 64, and is connected to the memory 65, to invoke a program in the memory 65 to perform an operation of the network-side device shown in the foregoing method embodiment.

The baseband apparatus 63 may further include a network interface 66 for exchanging information with the radio frequency apparatus 62. The interface is, for example, a common public radio interface (common public radio interface, CPRI).

The processor herein may be one processor, or may be a general name of multiple processing elements. For example, the processor may be a CPU, or may be an ASIC, or one or more integrated circuits configured to implement the method performed by the foregoing network-side device, for example, one or more microprocessors DSPs, or one or more field programmable gate arrays FPGAs. A storage element may be one memory, or may be a general name of multiple storage elements.

The memory 65 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). The memory 65 described in this application is intended to include but is not limited to these and any other suitable type of memory.

An embodiment of this application further provides a readable storage medium. The readable storage medium stores a program or an instruction, and the program or the instruction, when executed by a processor, implements the processes of the embodiments of the positioning measurement reporting method or the positioning measurement configuration method, and a same technical effect can be achieved. To avoid repetition, details are not described herein again.

The processor is a processor in the electronic device in the foregoing embodiment. The readable storage medium includes a computer-readable storage medium such as a read-only memory (Read-Only Memory, ROM), a random access memory (Random Access Memory, RAM), a magnetic disk, an optical disc, or the like.

An embodiment of this application further provides a chip, where the chip includes a processor and a communication interface, the communication interface is coupled to the processor, and the processor is configured to run a program or an instruction to implement the processes of the embodiments of the positioning measurement reporting method or the positioning measurement configuration method, and a same technical effect can be achieved. To avoid repetition, details are not described herein again.

It should be understood that the chip mentioned in the embodiments of this application may also be referred to as a system-on-chip, a system chip, a chip system, a system-on-a-chip, or the like.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of more restrictions, an element defined by the statement “including a . . . ” does not preclude the presence of other identical elements in the process, method, article, or apparatus that includes the element. Furthermore, it should be noted that the scope of the method and the apparatus in the embodiments of this application is not limited to performing a function in the order shown or discussed, but may also include performing the function in a substantially simultaneous manner or in a reverse order based on involved functions. For example, the described method may be performed according to a sequence different from the described sequence, and various steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of this application essentially, or the part contributing to the prior art may be implemented in a form of a software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of this application.

The embodiments of this application are described with reference to the accompanying drawings. However, this application is not limited to the foregoing specific implementations. The foregoing specific implementations are merely examples, but are not limiting. A person of ordinary skill in the art may make many forms without departing from the objective and the scope of the claims of this application, and these forms all fall within the protection scope of this application.

1. A positioning measurement reporting method performed by a terminal, comprising:
obtaining priority information of positioning; and
performing at least one of the following operations based on the priority information:
measuring a positioning signal; or
reporting positioning information.

2. The positioning measurement reporting method according to claim 1, wherein the obtaining priority information of positioning comprises any one of the following:
receiving priority configuration information sent by a network-side device, wherein the priority configuration information comprises the priority information;
obtaining the priority information defined by a protocol;
obtaining the priority information which is pre-configured; and
determining, by the terminal, the priority information.

3. The positioning measurement reporting method according to claim 1, wherein in a case that the positioning information is positioning information associated with the positioning signal, and the terminal need to perform measuring the positioning signal and reporting positioning information, based on the priority information,
a priority order of measuring the positioning signal is consistent with a priority order of reporting the positioning information.

4. The positioning measurement reporting method according to claim 1, wherein the priority information is configured for at least one of the following target objects:
a positioning mode;
a type of reported positioning information;
a type of a positioning measurement quantity;
a transmission and reception point (TRP);
a positioning frequency layer;
a positioning signal resource set; or
a positioning signal resource,
wherein in a case that the priority information is configured for the positioning signal resource set and/or the positioning signal resource, the priority information comprises at least one of the following priority rules:
prioritizing based on a type of the positioning signal;
prioritizing based on whether the positioning signal is within a measurement time window;
prioritizing based on whether the positioning signal is within a measurement gap time window;
prioritizing based on whether the positioning signal has an associated spatial reference signal;
prioritizing based on whether the positioning signal has an associated quasi-co-location reference signal;
prioritizing based on a measurement quality of the positioning signal; or
prioritizing based on priorities/a priority of the positioning signal resource and/or the positioning signal resource set indicated by the network-side device.

5. The positioning measurement reporting method according to claim 1, wherein the reporting positioning information based on the priority information comprises:
reporting positioning information corresponding to a target object for which the priority information is configured, based on at least one reporting mode, wherein the reporting mode comprises: aperiodic reporting, periodic reporting, semi-persistent reporting, event-triggered reporting, immediate reporting, early fix reporting, and non-connected state reporting.

6. The positioning measurement reporting method according to claim 5, wherein the priority information comprises a priority of the reporting mode, and the priority of the reporting mode comprises at least one of the following:
a priority of the aperiodic reporting is higher than a priority of the periodic reporting;
a priority of the aperiodic reporting is higher than a priority of the semi-persistent reporting;
a priority of the aperiodic reporting is higher than a priority of the immediate reporting;
a priority of the aperiodic reporting is higher than a priority of the early fix reporting;
a priority of the semi-persistent reporting is higher than a priority of the periodic reporting; or
a priority of the early fix reporting is higher than a priority of the immediate reporting, or
wherein the priority information comprises a priority of reporting the positioning information and a priority of the reporting mode, and the reporting positioning information corresponding to a target object for which the priority information is configured, based on at least one reporting mode comprises: reporting the positioning information corresponding to the target object for which the priority information is configured, based on a first reporting mode, wherein a priority of the first reporting mode matches a priority of the positioning information.

7. The positioning measurement reporting method according to claim 1, wherein the priority information comprises a priority of the positioning signal, and the measuring a positioning signal based on the priority information comprises:
in a case that a first positioning signal is unavailable, measuring a second positioning signal, wherein a priority of the second positioning signal is lower than a priority of the first positioning signal, or
the priority information comprises a priority of reporting the positioning information, and the reporting positioning information based on the priority information comprises:
in a case that first positioning information is unavailable, reporting second positioning information, wherein a priority of the second positioning information is lower than a priority of the first positioning information.

8. The positioning measurement reporting method according to claim 7, further comprising:
reporting a reason correspond to the first positioning signal is unavailable to the network-side device, or
reporting a reason correspond to the first positioning information is unavailable to the network-side device.

9. The positioning measurement reporting method according to claim 1, wherein the reporting positioning information based on the priority information comprises:
in a case that a resource required for all the positioning information exceeds an uplink resource, reporting, based on the priority information, part of the positioning information that can be carried in the uplink resource.

10. The positioning measurement reporting method according to claim 9, wherein after the reporting, based on the priority information, part of the positioning information that can be carried in the uplink resource, the method further comprises:
performing any of the following operations on unreported positioning information:
delaying reporting the unreported positioning information;
reporting the unreported positioning information based on an indication of the network-side device; and
canceling reporting the unreported positioning information.

11. The positioning measurement reporting method according to claim 1, wherein the priority information comprises a measurement priority of the positioning signal, and the measuring a positioning signal based on the priority information comprises at least one of the following:
performing a first operation, wherein the first operation is: measuring a positioning signal with a measurement priority higher than a first preset priority; or
performing a second operation, wherein the second operation is: not measuring a positioning signal with a measurement priority not higher than a second preset priority.

12. The positioning measurement reporting method according to claim 1, wherein the priority information comprises a priority of reporting the positioning information, and the reporting positioning information based on the priority information comprises at least one of the following:
performing a third operation, wherein the third operation is: reporting positioning information with a priority higher than a third preset priority; or
performing a fourth operation, wherein the fourth operation is: not reporting positioning information with a priority not higher than a fourth preset priority.

13. The positioning measurement reporting method according to claim 1, wherein before the obtaining priority information of positioning, the method further comprises:
reporting priority information of positioning that is expected by the terminal to the network-side device.

14. A positioning measurement configuration method performed by a network-side device, comprising:
sending priority configuration information to a terminal, wherein the priority configuration information comprises priority information of positioning, and the priority information is used to perform at least one of the following operations:
measuring a positioning signal; or
reporting positioning information.

15. The positioning measurement configuration method according to claim 14, wherein the priority information is configured for at least one of the following target objects:
a positioning mode;
a type of reported positioning information;
a type of a positioning measurement quantity;
a transmission and reception point (TRP);
a positioning frequency layer;
a positioning signal resource set; or
a positioning signal resource.

16. The positioning measurement configuration method according to claim 14, wherein in a case that the priority information is used to report the positioning information, the target object corresponding to the priority information comprises at least one of the following reporting modes: aperiodic reporting, periodic reporting, semi-persistent reporting, event-triggered reporting, immediate reporting, early fix reporting, or non-connected state reporting.

17. The positioning measurement configuration method according to claim 16, wherein the terminal is configured with a plurality of reporting modes, the priority information comprises a priority of the reporting mode, and the priority of the reporting mode comprises at least one of the following:
a priority of the aperiodic reporting is higher than a priority of the periodic reporting;
a priority of the aperiodic reporting is higher than a priority of the semi-persistent reporting;
a priority of the aperiodic reporting is higher than a priority of the immediate reporting;
a priority of the aperiodic reporting is higher than a priority of the early fix reporting;
a priority of the semi-persistent reporting is higher than a priority of the periodic reporting; or
a priority of the early fix reporting is higher than a priority of the immediate reporting.

18. The positioning measurement configuration method according to claim 16, wherein the terminal is configured with a plurality of reporting modes, the priority information comprises a priority of reporting the positioning information and a priority of the reporting mode, and the priority of the reporting mode for reporting the positioning information matches the priority of the positioning information.

19. The positioning measurement configuration method according to claim 14, wherein before the sending priority configuration information to a terminal, the method further comprises:
receiving priority information of positioning that is reported and expected by the terminal.

20. An electronic device, comprising:
a processor; and
a memory storing a program or an instruction that is executable on the processor, wherein the program or the instruction, when executed by the processor, causes the electronic device to:
obtain priority information of positioning; and
perform at least one of the following operations based on the priority information:
measuring a positioning signal; or
reporting positioning information, or
sending priority configuration information to a terminal, wherein the priority configuration information comprises priority information of positioning, and the priority information is used to perform at least one of the following operations:
measuring a positioning signal; or
reporting positioning information.
